(19) United States
(12) Patent Application Publication
(10) Pub. No.: US 2010/0134432 A1
(43) Pub. Date: Jun. 3, 2010

(54) METHOD AND APPARATUS TO PROVIDE USER INTERFACE

(75) Inventor: Hyeong-chan SEO, Busan (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/575,033

(22) Filed: Oct. 7, 2009

(30) Foreign Application Priority Data
Dec. 1, 2008 (KR) 2008-120503

(51) Int. Cl. G06F 3/041; G06F 3/048

(52) U.S. Cl. 345/173; 715/846

(57) ABSTRACT

A method of operating a touch screen providing an enhanced user interface includes displaying a plurality of icons on a touch screen, determining whether or not confusion occurs, and enlarging an area in which confusion occurs. Accordingly, a user can select a desired icon with greater ease and greater precision.

### CROSS-REFERENCE TO RELATED APPLICATIONS

This application claims priority under 35 U.S.C. §119 (a) from Korean Patent Application No. 10-2008-0120503, filed on Dec. 1, 2008, in the Korean Intellectual Property Office, the disclosure of which is incorporated herein by reference in its entirety.

### BACKGROUND

1. Field of the Invention

The present general inventive concept relates to a method to provide a user interface and a multimedia apparatus using the same. More particularly, the present general inventive concept relates to a method to enlarge a confusing area which is caused when a user erroneously touches two or more icons from among a plurality of icons which are arranged densely on a touch screen.

2. Description of the Related Art

Recently, there has been an increase in the number and type of functions provided by multimedia apparatuses. This increase has been realized by applying digital techniques to image apparatuses.

Due to having so many functions, it can be complicated for a user to manipulate multimedia apparatuses. In order to facilitate manipulation, a touch screen is used widely so that the user can manipulate multimedia apparatuses with greater ease and with greater convenience.

If a device having a touch screen displays menu icons on the touch screen, the user touches one of the icons to execute a program corresponding to the touched icon. In general, if the user touches a plurality of icons at a time or a non-icon area, the device generates an error signal or does not operate until a normal touch is input. However, if the device does not operate until a normal touch is input, abnormal touches may occur again.

Therefore, there is a need for methods for leading the user to input normal touches.

### SUMMARY

The present general inventive concept provides a method to enable a user to select a desired icon with greater convenience and with greater precision by enlarging a confusing area which is caused when the user erroneously touches two or more icons from among a plurality of icons which are arranged densely on a touch screen or when the user touches an empty area between the icons.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method to provide a user interface, the method including displaying a plurality of icons on a touch screen, determining whether or not confusion occurs if the touch screen is touched, and enlarging and displaying a confusing area if confusion occurs.

The confusing area may be an area on which at least two icons from among the plurality of icons are touched.

The enlarging and displaying operation may include dividing the touch screen into a number of the touched icons, and enlarging and displaying the at least two touched icons on the divided areas of the touch screen, respectively.

The enlarging and displaying operation may include enlarging and displaying the at least two touched icons and at least one icon which is adjacent to the at least two touched icons.

The enlarging and displaying operation may further include displaying together an icon for returning to the touch screen which has been displayed before the enlarging operation is performed.

The confusing area may be an empty area on the touch screen on which there is no icon.

The enlarging and displaying operation may include dividing the touch screen into a number of at least one icon which is adjacent to the empty area, and enlarging and displaying the at least one adjacent icon on the divided area of the touch screen, respectively.

The enlarging and displaying operation may include enlarging and displaying at least one icon which is adjacent to the empty area.

The enlarging and displaying operation may further include displaying together an icon for returning to the touch screen which has been displayed before the enlarging operation is performed.

The foregoing and/or other aspects and utilities of the present general inventive concept may be achieved by providing a multimedia apparatus, including a touch screen to display a plurality of icons, and a control to determine whether or not confusion occurs if the touch screen is touched, and to enlarge and display a confusing area if confusion occurs.

The confusing area may be an area on which at least two icons from among the plurality of icons are touched.

If confusion occurs, the control unit may divide the touch screen into a number of the touched icons, and enlarge and display the at least two touched icons on the divided areas of the touch screen, respectively.

If confusion occurs, the control unit may enlarge and display the at least two touched icons and at least one icon which is adjacent to the at least two touched icons.

If confusion occurs, the control unit may display together an icon for returning to the touch screen which has been displayed before the enlarging operation is performed.

The confusing area may be an empty area on the touch screen on which there is no icon.

If confusion occurs, the control unit may divide the touch screen into a number of at least one icon which is adjacent to the empty area, and enlarge and display the at least one adjacent icon on the divided area of the touch screen, respectively.

If confusion occurs, the control unit may enlarge and display at least one icon which is adjacent to the empty area.

The control unit may display together an icon for returning to the touch screen which has been displayed before the enlarging operation is performed.

The foregoing and/or other aspects and utilities of the present general inventive concept may be achieved by providing a handheld device including a touch screen to display a plurality of icons and a control unit to determine that confusion occurs in response to the touch screen being touched, and to enlarge and display a confusing area when confusion occurs.

The foregoing and/or other aspects and utilities of the present general inventive concept may be achieved by providing a wireless communication device including a touch screen to display a plurality of icons, and a control to determine that confusion occurs when the touch screen is touched, and to enlarge and display a confusing area when confusion occurs.

The foregoing and/or other aspects and utilities of the present general inventive concept may be achieved by providing a computer-readable medium to contain computer-readable codes as a program to perform a method of setting network information of an apparatus, the method including sending display information of a plurality of icons to a touch screen display, determining that confusion occurs when touch screen information is received from the touch screen display, and sending enlarged display information of a confusing area to the touch screen display when confusion occurs.

The foregoing and/or other aspects and utilities of the present general inventive concept may be achieved by providing a multimedia apparatus including a touch screen to display a plurality of icons, and a control to receive a selection of enlargement or division mode, to determine that confusion occurs when the touch screen is touched, and to enlarge and display a confusing area when confusion occurs.

The foregoing and/or other aspects and utilities of the present general inventive concept may be achieved by providing a method of providing a user interface, the method including receiving a selection of enlargement or division mode, displaying a plurality of icons on a touch screen, determining that confusion occurs when the touch screen is touched and enlarging and displaying a confusing area when confusion occurs.

The foregoing and/or other aspects and utilities of the present general inventive concept may be achieved by providing a computer-readable medium to contain computer-readable codes as a program to perform a method of setting network information of an apparatus, the method including receiving information selecting an enlargement mode or division mode, sending display information of a plurality of icons to a touch screen display, determining that confusion occurs when touch screen information is received from the touch screen display, and sending enlarged display information of a confusing area to the touch screen display when confusion occurs.

The foregoing and/or other aspects and utilities of the present general inventive concept may be achieved by providing a multimedia apparatus, including a touch screen to display a plurality of icons and to generate signals representing a touch of one or more icons; and a control unit to emphasize at least two of the icons according to the signal.

The control unit may select at least two of the icons among the plurality of icons and may control the touch screen to display the selected icons:

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a flow chart illustrating a method to provide a user interface according to an exemplary embodiment of the present general inventive concept;

FIG. 2 is a flow chart illustrating an enlargement mode;

FIG. 3 is a flow chart illustrating a method to provide a user interface according to an exemplary embodiment of the present general inventive concept;

FIG. 4 is a flow chart illustrating a division mode;

FIG. 5 illustrates a touch screen on which a plurality of menu icons are displayed;

FIG. 6 illustrates a touch screen which is generated after a confusing area is generated;

FIG. 7 illustrates a process of enlarging icons on the touch screen in the division mode;

FIG. 8 illustrates a process of enlarging icons on the touch screen in the division mode;

FIG. 9 illustrates a touch screen on which an empty area is touched;

FIG. 10 illustrates a touch screen in the enlargement mode when an empty area is touched; and

FIG. 11 is a block diagram illustrating a configuration of a multimedia apparatus having a touch screen operating method.

### DETAILED DESCRIPTION OF THE EMBODIMENTS

Reference will now be made in detail to the present embodiments of the present general inventive concept, examples of which are illustrated in the accompanying drawings, wherein like reference numerals refer to like elements throughout. The embodiments are described below in order to explain the present general inventive concept by referring to the figures.

When a user manipulates a multimedia apparatus having a touch screen, the user may touch a plurality of icons on the touch screen at a time since the icons on the touch screen are small or are closely positioned. Alternatively, if the icons are positioned at intervals, the user may touch a non-icon area (referred to hereinafter as “empty area”).

If an incorrect or abnormal touch is received as input, a conventional multimedia apparatus generates an error signal that leads the user to touch a desired icon again or does not operate until a normal touch is input.

In order to resolve such problems with input on a touch screen, the present general inventive concept enlarges and displays a plurality of icons in a touched area on a touch screen or a plurality of icons which are adjacent to the touched area, so the user can more easily select a desired icon.

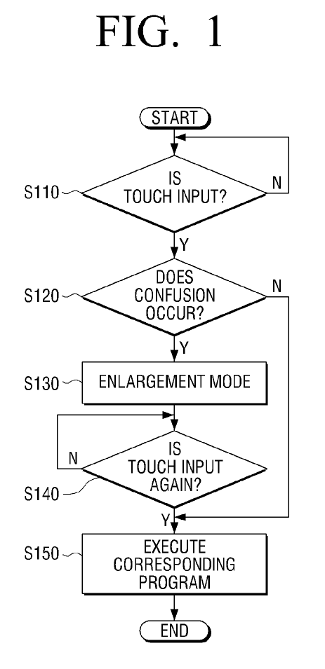

Hereinafter, a method to operate a touch screen is described in detail with reference to the accompanying drawings. FIG. 1 is a flow chart illustrating a method to provide a user interface according to an exemplary embodiment of the present general inventive concept.

The touch screen described hereinbelow may be a capacitive or resistive touch screen, or any other suitable touch screen, as is known in the art. A typical capacitive touch screen panel may be made of glass coated with a transparent conductor such as indium tin oxide (ITO). This type of sensor is a basic capacitor in which the plates are the overlapping areas between the horizontal and vertical axes in a grid pattern. Since the human body conducts electricity, a touch on the surface of the sensor will affect the electric field and create a measurable change in the capacitance of the device. The resolution of the grid or matrix of the touch screen may be used to assist in determining which icon is touched. The touch may be by a user's finger or fingernail or by a stylus, or by another method, as is known in the art. The touch may be a short touch, a long touch, or a motion touch, such as a swipe.

In operation S110, a device determines whether or not a user touches a touch screen on which a plurality of icons are densely arranged.

In operation S120, the device determines whether or not confusion is caused by the touch. Confusion occurs when, due to an imprecise touch, the device cannot determine which icon the user has touched. Confusion may occur when the user touches a plurality of icons at a time or when the user touches a non-icon area, that is, touches an empty area.

Confusion may also occur when at least one icon and a space adjacent to the icon are touched. Confusion may also occur when at least one icon is touched with a motion touch, i.e., a swipe of a finger. Confusion may also occur when the device is unable to determine which icon, if any, is intended to be selected. As described above, a typical touch screen is divided into a grid or matrix with a resolution, so that a touch may be interpreted ambiguously or unambiguously, depending upon the location of the touch and the resolution of the grid or matrix of the touch screen.

In operation S120-N, if a normal touch is input and no confusion occurs, in operation S150 the device executes a program corresponding to the touched icon. In operation S120-Y, if instead an incorrect or abnormal touch is input and confusion occurs, in operation S130 the device changes a display mode to an enlargement mode.

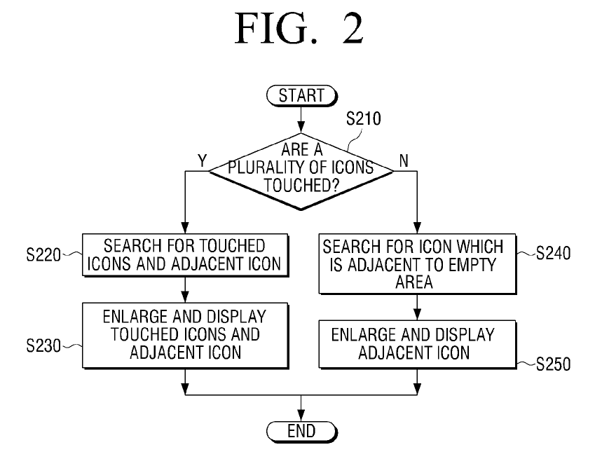

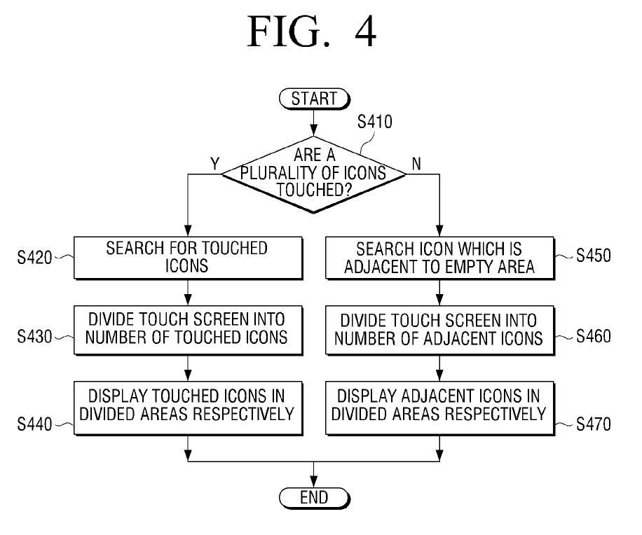

The device can be preset whether or not to change a display mode to the enlargement mode if confusion occurs because of the touch. Accordingly, if the device is preset to change a display mode to a division mode rather than the enlargement mode, the device operates in the division mode. The enlargement mode and the division mode will be described later with reference to FIGS. 2 and 4.

In operation S130, if the display mode is changed into the enlargement mode, in operation S140 the device determines whether or not the user touches an icon on the touch screen in the enlargement mode.

In operation S140-Y, if the device determines that the user normally touches an icon in the enlargement mode, in operation S150 the device executes a program corresponding to the normally touched icon.

Hereinafter, the enlargement mode is described in detail with reference to FIG. 2, which is a flow chart illustrating an exemplary embodiment of the enlargement mode.

In the enlargement mode, if an area touched by the user includes a plurality of icons, at least one adjacent icon is enlarged and displayed together with the plurality of icons, and if an area touched by the user is an empty area, at least one icon which is adjacent to the empty area is enlarged and displayed.

In the enlargement mode, icons which are adjacent to the touched area are displayed as described above so that the user can have more selectable icon choices.

In operation S210, in the enlargement mode, the device determines whether or not the user touches a plurality of icons.

In operation S210-Y, if the area touched by the user includes a plurality of icons and confusion occurs, in operation S220 the device searches for the plurality of touched icons and at least one icon which is adjacent to the plurality of touched icons.

In operation S230, the device enlarges and displays the searched icons on the touch screen, including the plurality of touched icons and at least one adjacent icon.

In operation S210-N, if the area touched by the user does not include a plurality of icons and instead is an empty area, then confusion occurs, and in operation S240 the device determines that an empty area is touched and thus searches for at least one icon which is adjacent to the empty area.

In operation S250, the device enlarges and displays the searched icon on the touch screen. The device may also enlarge and display two or more icons that are adjacent to the empty area that was touched.

Accordingly, the device can provide the user with a more selectable icon area when a confusing area is generated.

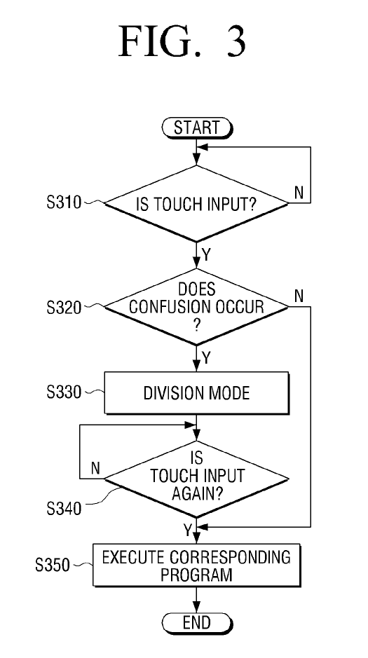

FIG. 3 is a flow chart illustrating a method for providing a user interface according to an exemplary embodiment of the present general inventive concept.

In operation S310, the device determines whether or not the user touches the touch screen on which a plurality of icons are densely arranged.

In operation S320, the device determines whether or not confusion is caused by the touch. As above, confusion occurs when the user touches more than one icon simultaneously or when the user touches an empty area with no icons.

In operation S320-N, if a normal touch is input and no confusion occurs, in operation S350 the device executes a program corresponding to the touched icon. In operation S320-Y, if an incorrect or abnormal touch is input and confusion occurs, in operation S330 the device changes a display mode to a division mode.

In operation S330, if the display mode is changed into the division mode, in operation S340 the device determines whether or not the user touches an icon on the touch screen in the division mode.

In operation S340-Y, if the device determines that the user normally touches an icon while in the division mode, in operation S350 the device executes a program corresponding to the normally touched icon.

Hereinafter, the division mode is described in detail with reference to FIG. 4, which is a flow chart illustrating the division mode.

In the division mode, if an area touched by the user includes a plurality of icons, the touch screen is divided into the number of touched icons and the touched icons are enlarged and displayed in the divided areas of the touch screen, respectively. If an area touched by the user is an empty area, the touch screen is divided into the number of icons adjacent to the empty area and the adjacent icons are enlarged and displayed in the divided areas of the touch screen, respectively. If the area touched by the user is an empty area, then at least one icon adjacent to the empty area may be enlarged and displayed. If two or more icons are adjacent to the empty area, then two or more icons may be enlarged and displayed.

In the division mode, the touch screen is divided to display icons so that the user can use a visually improved touch screen.

In operation S410, in the division mode, the device determines whether or not the user touches a plurality of icons.

In operation S410-Y, if the touched area by the user includes a plurality of icons and confusion occurs, in operation S420 the device searches for the plurality of touched icons.

In operation S430, the device divides the touch screen into the number of touched icons, and enlarges and displays the searched icons in the divided areas of the touch screen, respectively.

For example, if the user touches four icons, the touch screen is divided into four quarters, and the four icons are enlarged at a certain magnification and displayed on the four divided areas of the touch screen, respectively.

In operation S410-N, if the touched area by the user does not include any icons and confusion occurs, in operation S440 the device determines that an empty area is touched. Accordingly, in operation S450, the device searches for at least one icon which is adjacent to the empty area.

In operation S460, the device divides the touch screen into the number of searched icons, and in operation S470, enlarges and displays the searched icons on the divided areas of the touch screen, respectively.

For example, if the user touches an empty area on the touch screen and there are three icons which are adjacent to the empty area, the device divides the touch screen into three areas, and enlarges the three adjacent icons at a certain magnification and displays the three enlarged adjacent icons on the three divided areas of the touch screen, respectively.

Therefore, the device can provide the user with a visually improved touch screen when a confusing area is generated.

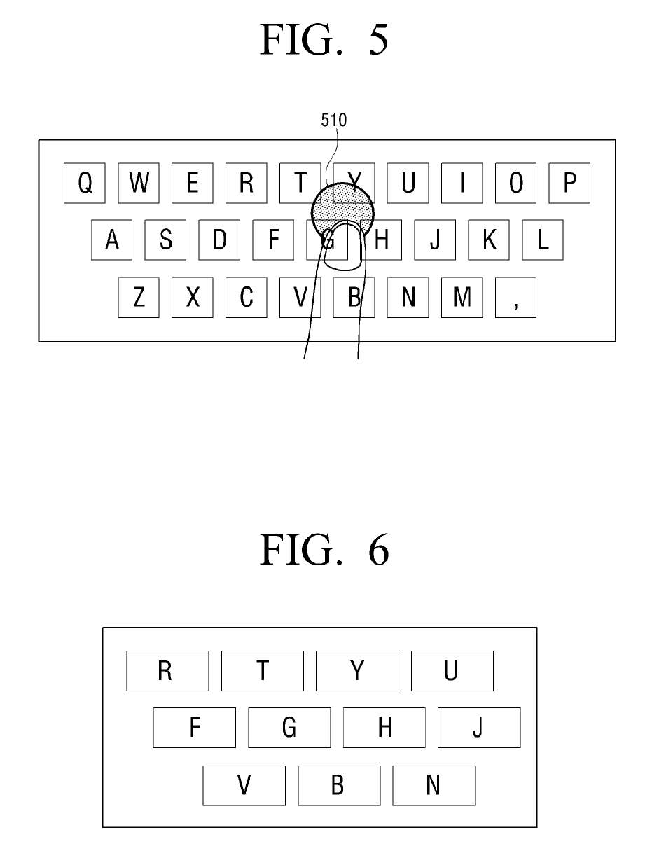

Hereinafter, an exemplary process of enlarging icons in the enlargement mode is described with reference to FIGS. 5 and 6. FIG. 5 illustrates a touch screen on which a plurality of menu icons are displayed, and FIG. 6 illustrates a touch screen which is generated after a confusing area is generated.

The menu icons may be icons representing a letter, a number, or a character. The menu icons may be images representing a program, command, or request. The menu icons may be a section to enter data or a character/number from the character/number icons. The menu icons may be other input icons.

Referring to FIG. 5, the touch screen displays a plurality of menu icons. In this example, the user intends to touch icon “Y”, but actually touches four icons “T”, “Y”, “G”, and “H”.

The device enlarges and displays icons based on the touched confusing area 510. That is, the four icons “T”, “Y”, “G”, and “H” and adjacent icons “R”, “F”, “V”, “B”, “N”, “J”, and “U” are enlarged and displayed on the touch screen as illustrated in FIG. 6. While eleven enlarged icons are shown in FIG. 6, it should be understood that a smaller number of larger icons may be displayed, or a larger number of smaller icons may be displayed.

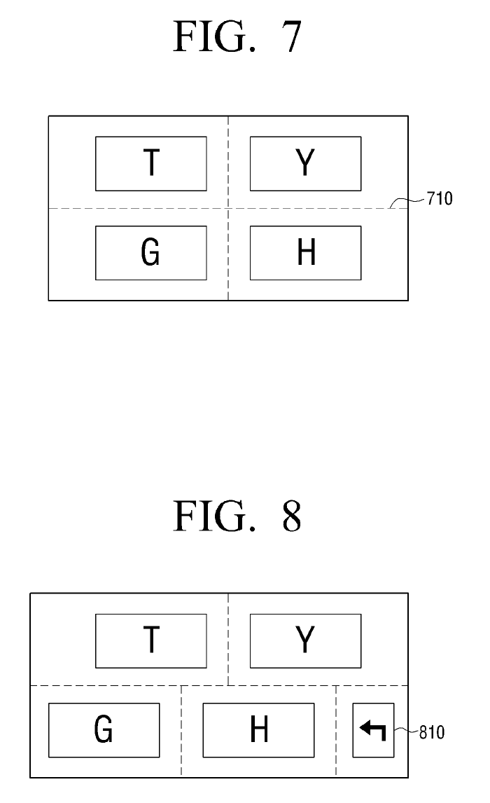

Hereinafter, an exemplary process of enlarging icons in the division mode is described with reference to FIGS. 7 and 8, which illustrate a process of enlarging icons in the division mode.

As illustrated in FIG. 5, the user intends to touch icon “Y”, but actually touches four icons “T”, “Y”, “G”, and “H”.

Subsequently, referring to FIG. 7, the device divides the touch screen into the number of touched icons, and enlarges and displays the four icons “T”, “Y”, “G”, and “H” on the divided areas of the touch screen, respectively. In FIG. 7, the divided areas are expressed using dotted lines 710. However, the present general inventive concept may apply to even when the divided areas are expressed using solid lines, the touch screen is invisibly and virtually divided, or the touch screen is divided using other methods.

If the user wishes to select an icon other than the four icons “T”, “Y”, “G”, and “H”, the user may wish to return to the touch screen which has been displayed before “T”, “Y”, “G”, and “H” are enlarged.

In order to do so, the device can display a return icon 810 as well as “T”, “Y”, “G”, and “H” as illustrated in FIG. 8. Accordingly, by touching the return icon 810 the user can return to the touch screen which has been displayed before “T”, “Y”, “G”, and “H” are enlarged.

In addition, as illustrated in FIG. 8, the touch screen is divided into the sum of the number of touched icons and the number of return icon 810, and thus displays the four icons “T”, “Y”, “G”, and “H” and the return icon 810.

In the division mode, the return icon 810 is displayed but this is merely an exemplary embodiment of the present general inventive concept for convenience of description. Accordingly, the return icon 810 may be displayed in the enlargement mode as well as in the division mode, and whether or not to display the return icon 810 can be set by the user.

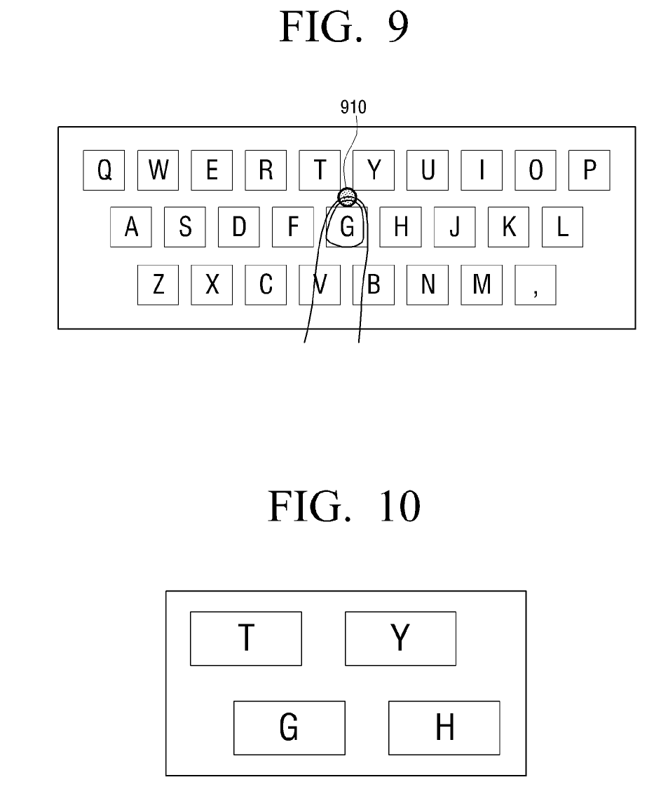

Hereinafter, an exemplary process of enlarging icons when the user touches an empty area is described with reference to FIGS. 9 and 10.

FIG. 9 illustrates a touch screen on which an empty area is touched, and FIG. 10 illustrates a touch screen in the enlargement mode when an empty area is touched.

The user intends to touch icon “Y” from among the menu icons, but actually touches an empty area 910 between four icons “T”, “Y”, “G”, and “H”.

In the enlargement mode, if the empty area 910 is touched, the four icons “T”, “Y”, “G”, and “H” which are adjacent to the empty area 910 are enlarged and displayed as illustrated in FIG. 10.

In the division mode, if the empty area 910 is touched, the touch screen is divided into the number of icons which are adjacent to the empty area, and the four icons “T”, “Y”, “G”, and “H” are enlarged and displayed on the divided areas of the touch screen, respectively, similarly to the display illustrated in FIG. 7.

In either the enlargement mode or division mode described hereinabove, at least one icon is enlarged. However, at least one icon may instead be emphasized in a different manner than enlargement, such as by bolding, by changing the color of the icon or icons or of the non-touched icons, by placing a box around the icon or icons, or by some other method of emphasis.

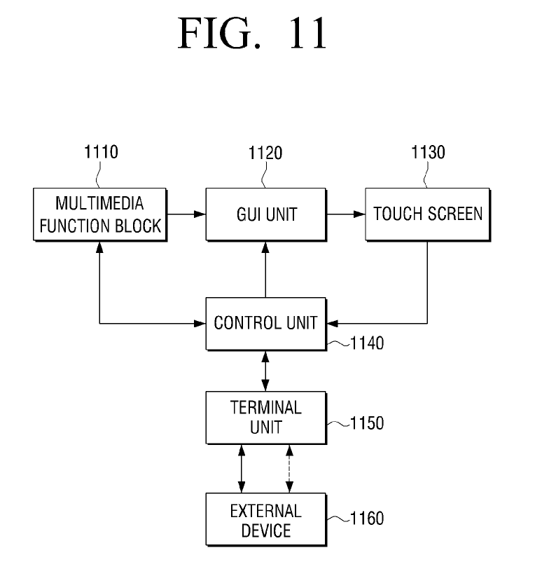

FIG. 11 is a block diagram illustrating an exemplary configuration of a multimedia apparatus using the touch screen operating method as described above. The multimedia apparatus may be a portable or handheld device such as a personal organizer or data assistant, a wireless communication device, or other multimedia device with a touch screen, such as a camera or video recorder.

Referring to FIG. 11, the multimedia apparatus may include a multimedia function block 1110, a graphical user interface (GUI) unit 1120, a touch screen 1130, and a control unit 1140. The multimedia apparatus may optionally include a terminal unit 1150 to communicate with an external device 1160 in a wired or wireless connection.

The multimedia function block 1110 performs the functions of the multimedia apparatus such as, for example, file searching, game, recording, music playback, movie playback, picture playback, document writing, and Digital Multimedia Broadcasting (DMB) playback.

The GUI unit 1120 generates a GUI such as menu icons.

The touch screen 1130 displays the icons generated by the GUI unit 1120, and receives the user's input such as a touch, a long touch, and dragging.

The control unit 1140 controls the multimedia function block 1110 according to a user command which is input through the touch screen 1130 or a manipulation means (not shown).

In addition, the control unit 1140 controls the GUI unit 1120 to display a GUI on the touch screen 1130 according to a user command.

More specifically, the user's incorrect touch on the touch screen 1130 causes confusion, the control unit 1140 determines the set mode of the multimedia apparatus and controls the touch screen 1130 to display the screen according to the enlargement mode or the division mode.

The control unit 1140 communicates with an optional terminal unit 1150 that is used to communicate with an external device 1160. The external device 1160 may be a computer or a file storage system, or may be a wireless communications network for a wireless communication device, or may be another suitable external device for a multimedia apparatus.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As can be appreciated from the above description of the exemplary embodiments of the present general inventive concept, the user can select a desired icon with greater ease and greater precision.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of providing a user interface, the method comprising:
displaying a plurality of icons on a touch screen;
determining that confusion occurs in response to the touch screen being touched; and
enlarging and displaying a confusing area when confusion occurs.

2. The method according to claim 1, wherein the confusing area is an area on which at least two icons from among the plurality of icons are touched.

3. The method according to claim 2, wherein the enlarging and displaying operation comprises:
dividing the touch screen into a number of the touched icons; and
enlarging and displaying the at least two touched icons on the divided areas of the touch screen, respectively.

4. The method according to claim 2, wherein the enlarging and displaying operation comprises:
enlarging and displaying the at least two touched icons and at least one icon which is adjacent to the at least two touched icons.

5. The method according to claim 3, wherein the enlarging and displaying operation further comprises:
displaying together an icon for returning to the touch screen which has been displayed before the enlarging operation is performed.

6. The method according to claim 4, wherein the enlarging and displaying operation further comprises:
displaying together an icon for returning to the touch screen which has been displayed before the enlarging operation is performed.

7. The method according to claim 1, wherein the confusing area is an empty area on the touch screen on which there is no icon.

8. The method according to claim 7, wherein the enlarging and displaying operation comprises:
dividing the touch screen into a number of at least one icon which is adjacent to the empty area; and
enlarging and displaying the at least one adjacent icon on the divided area of the touch screen, respectively.

9. The method according to claim 7, wherein the enlarging and displaying operation comprises:
enlarging and displaying at least one icon which is adjacent to the empty area.

10. The method according to claim 7, wherein the enlarging and displaying operation further comprises:
displaying together an icon for returning to the touch screen which has been displayed before the enlarging operation is performed.

11. The method according to claim 8, wherein the enlarging and displaying operation further comprises:
displaying together an icon for returning to the touch screen which has been displayed before the enlarging operation is performed.

12. A multimedia apparatus, comprising:
a touch screen to display a plurality of icons; and
a control unit to determine that confusion occurs in response to the touch screen being touched, and to enlarge and display a confusing area when confusion occurs.

13. The multimedia apparatus according to claim 12, wherein the confusing area is an area on which at least two icons from among the plurality of icons are touched.

14. The multimedia apparatus according to claim 13, wherein when confusion occurs, the control unit divides the touch screen into a number of the touched icons, and enlarges and displays the at least two touched icons on the divided areas of the touch screen, respectively.

15. The multimedia apparatus according to claim 13, wherein when the control unit determines confusion occurs, the control unit enlarges and displays the at least two touched icons and at least one icon which is adjacent to the at least two touched icons.

16. The multimedia apparatus according to claim 12, wherein when the control unit determines confusion occurs, the control unit further displays an icon for returning to the touch screen which has been displayed before the enlarging operation is performed.

17. The multimedia apparatus according to claim 13, wherein when the control unit determines confusion occurs, the control unit further displays an icon for returning to the touch screen which has been displayed before the enlarging operation is performed.

18. The multimedia apparatus according to claim 12, wherein the confusing area is an empty area on the touch screen on which there is no icon.

19. The multimedia apparatus according to claim 18, wherein when the control unit determines confusion occurs, the control unit divides the touch screen into a number of at least one icon which is adjacent to the empty area, and enlarges and displays the at least one adjacent icon on the divided area of the touch screen, respectively.

20. The multimedia apparatus according to claim 18, wherein when the control unit determines confusion occurs, the control unit enlarges and displays at least one icon which is adjacent to the empty area.
